(19) United States
(12) Patent Application Publication
(10) Pub. No.: US 2008/0230310 A1
(43) Pub. Date: Sep. 25, 2008

(54) Curved Panel for Acoustical Shell, Method of Manufacturing the Same, and Acoustical Shell Using the Same

(75) Inventor: Myong-Seok Kim, Incheon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SIKONGSA CO., LTD., Gyeonggi-Do (KR)

(21) Appl. No.: 11/572,704

(22) PCT Filed: Jul. 26, 2005
(86) PCT No.: PCT/KR2005/002414

§ 371 Date: Dec. 5, 2007

(30) Foreign Application Priority Data
Jul. 26, 2004 (KR) 10-2004-0058360
May 16, 2005 (KR) 20-2005-0013683

(51) Int. Cl. E04B 1/82; B27N 5/02

(52) U.S. Cl. 181/292; 156/221; 428/35.6

(57) ABSTRACT

The present invention provides an acoustical shell for stage sets which is light and easily handled, which has no deformation of a curved surface for a long-period installation, in which a surface to reflect sound is broad and it is possible to prevent a resonance phenomenon due to a cavity, thereby providing an excellent efficiency of reflecting the sound, without eliminating even any small sound. A method of manufacturing the acoustical shell according to the present invention comprises making a laminate board by bonding a melamine pasteboard and 2 to 4 sheets of plywood or MDF using adhesives, securing the laminate board into a wood winding machine made in a curved surface shape and applying a high frequency heat-treatment such that a bending is fixed to form a curved shape, making a upper board and a lower board using the curved board, adhesively inserting a plastic board attached framing members for edging between the upper and lower boards to be pressed for integrating, thereby manufacturing a curved panel. Then, the upper and lower ends and the right and left side ends of the curved panel are overlaid with aluminum profiles, thereby completing the acoustical shell.

### TECHNICAL FIELD

The present invention relates to an acoustical shell to be used in a concert hall. More particularly, the present invention relates to an acoustical shell which is light, has no deformation, has the efficiency of reflecting sound and is structured to prevent a resonance phenomenon by the cavities.

An acoustical shell is a facility to prevent sound generated by musical instruments of an orchestra, singing by a vocalist or a sound effect accompanying musical performance on the stage where the vocal or instrumental music is performed, from scattering toward the upper part, sides and rear part of the stage, and to reflect the sound such that the sound sufficiently travels an audience. The acoustical shell can be kept in an upper stage tower or in a side room when not used.

### BACKGROUND ART

A conventional acoustical shell panel has a structure wherein, a curved panel is formed by attaching plywoods to a frame, the frame being made in the keel shape of a ship by using a several framing members, each framing member having a surface curved angle of 1.5 m radius, or by forcibly bonding plywoods or MDF (Medium Density Fiberboard) with the frame having the curved angle. Thus, in such a conventional acoustical shell panel, there are the problems that the curved panel generally gets warped on the whole by the elastic force of the curved panel as time passes, the light from the back of a stage in a concert hall leaks through the opening between the boards, and too much energy is required to hang the panel on the ceiling of the hall, that is, to rig the panel because it is very heavy.

Hereupon, Korean Utility Model Publication No. 20-023215 discloses an acoustical shell manufactured by attaching a urethane bonded interior board, a honeycomb, and a urethane bonded exterior board to a frame and leaving it until the bond properly cures, and then by performing an outside finishing, wherein the outside frame comprises the aluminum upper and lower parts being linear and left and right side aluminum parts being in shape of circular arc having the curved angle. However, in the panel for the acoustical shell according to the prior art mentioned above, there is the defect in that, because the curved surface being temporarily forcibly bent is merely inserted into the aluminum frame, the curved surface is distorted or the boards lose their shape to cause an opening between the boards due to the elastic force of the panel itself as time passes. Thus, it is required that a support (i.e., an aluminum bar with the same curved angle as that of the panel) should be additionally provided on the rear side to keep the curved surface of the acoustical shell as it is, or a thicker and stronger aluminum frame should be used. In such a case, there are the problems in that the weight becomes heavy, and that, as a board should be installed as several smaller pieces to keep the curved surface shape, the work process becomes complicated by the increased number of connected portions.

Hereupon, an acoustical shell, wherein the panel by itself forms a curved surface because the original board is applied by heat treatment at its originally bending status when manufacturing the curved panel for the acoustical shell, and thus wherein no deformation occurs even after years of use, has been filed by the present inventor in Korean Patent Application No. 10-2004-0058360, Korean Utility Model Applications Nos. 20-2004-0021292 and 20-2004-0022746.

In the acoustical shell according to the above mentioned prior inventions, the curved panel has a structure where seven layers such as the following layers: a melamine pasteboard, two sheets of plywood, a honeycomb, two sheets of plywood, a melamine pasteboard are laminated, and has a rectangular shape (in which the curved surface takes a lengthwise shape).

The acoustical shell in this structure has the drawbacks in that a resonance phenomenon of sound occurs because the middle part, that is, the honeycomb layer, includes many cavities, and that the reflection of sound is not sufficient.

### DESCRIPTION OF DRAWINGS

FIG. 1 is a perspective view of a prior art acoustical shell;

FIG. 2 is an exploded perspective view of the acoustical shell according to the prior art;

FIG. 3 is a plane perspective view of an acoustic shell according to one embodiment of the present invention;

FIG. 4 is a rear perspective view of the acoustical shell of FIG. 3;

FIG. 5 is an exploded perspective view of the acoustical shell of FIG. 3;

FIG. 6 is a cross sectional view of the acoustical shell of FIG. 3, taken along the line A-A (transversely);

FIG. 7 is an enlarged longitudinal sectional view of the acoustical shell of FIG. 3;

FIG. 8 is a plane perspective view of an acoustical shell according to an another embodiment of the present invention;

FIG. 9 is a rear perspective view of the acoustical shell of FIG. 8;

FIG. 10 is an exploded perspective view of the acoustical shell of FIG. 8;

FIG. 11 is a cross sectional view of the acoustical shell of FIG. 8, taken along the line A-A (transversely);

FIG. 12 is an enlarged longitudinal sectional view of the acoustical shell of FIG. 8;

FIG. 13 is a sectional view of a curved aluminum profile according to the present invention; and

FIG. 14 is a sectional view of a linear aluminum profile according to the present invention.

### DISCLOSURE OF INVENTION

### Technical Problem

Therefore, the present invention is worked out to overcome the above problems of the prior art. An acoustical shell according to the present invention is accomplished by using a plastic board instead of the honeycomb portion used as an inserted mid-layer in the prior art acoustical shell, to remove the resonance phenomenon of sound and to sufficiently reflect even delicate/faint sounds.

An object of the present invention is to provide an acoustical shell which has no resonance phenomenon.

Another object of the present invention is to provide an acoustical shell which has the improved efficiency of reflection of sound.

Another object of the present invention is to provide a curved panel for an acoustical shell, and a method of manufacturing the same, which is thin in thickness and light and has no distortion phenomenon such that it can be used semi-permanently.

### Technical Solution

A curved panel for an acoustical shell according to the present invention comprises a laminate with 7 to 11 layers, i.e., laminated by using a melamine pasteboard, 2˜4 layers of MDF(s) and/or plywood(s), a plastic board, 2˜4 layers of plywood(s) and/or MDF(s), and a melamine pasteboard.

The acoustical shell according to the present invention is characterized in that a plastic board is present in-between as an inserted mid-layer. The acoustical shell according to the present invention wherein the plastic board is inserted in the middle is different from the acoustical shell according to the prior art having a honeycomb structure, in that the former can reflect sound at a high degree of efficiency because no resonance phenomenon occurs and the sound is not scattered. In the acoustical shell according to the present invention, there is also the advantage that not only the effect of sound reflection is improved but also it is easy to install. Further, there is merit in that, because the panel itself is manufactured as a curved surface, the acoustical shell according to the present invention retains its shape, is thin, light and solid. As the curved panel of the present invention is manufactured by heating its originally bending status such that the panel itself forms the curved shape, there is the desirable feature that it does not straighten or deform after long-time use.

The method of manufacturing the curved panel for the acoustical shell according to the present invention comprises forming a board by laminating a layer of melamine pasteboard, 2 to 4 layers of MDF(s) and plywood(s) by means of adhesives, for example, vinyl acetate emulsion adhesives, isocyanate urethane resin adhesives, urea resin adhesives, and applying heat treatment to the laminated board into a wood winding machine to form and secure the bending of the curved shape of board, wherein the wood winding machine is devised to provide the curved shape of 1.5 m or 3 m radius, such that the bending of the laminate is fixed in the form of a curved round surface. Usually, the temperature of the heat treatment depends on the kinds of adhesives as used and the time for curing. In the case of the vinyl acetate emulsion adhesives, the temperature of 70° C.˜80° C. is appropriate. If below 70° C., the time for curing is longer, and if above 80° C., the adhesives are apt to be burned. As general heat-treatment methods, there are direct heating, steam heating, and high frequency heating. However, if the high frequency heating is used, it is possible to prevent any carbonization and deterioration, and, first of all, it is advantageous to shorten the process time.

Next, a plastic board inserted as a mid-layer between an upper board and a lower board which made of the laminated board and then adhesively assembled them. The plastic board used in the present invention is made of plasto-synthetic resins, such as a foamed polyethylene board, a polyester staple fiber gypsum board, and a foamed polyethylene board with an aluminum foil being positioned in the middle. It is possible to purchase the boards in the market place. The adhesive is applied to the internal surface of the upper and lower boards, the plastic board is adhesively inserted between the upper and lower boards to be bonded, wherein the ends in the upper, lower, left and right sides of the plastic board is cut shorter by about 5 cm than the size of the panel, respectively, and at the edge of each end as cut, a framing member for edging is attached so as to be inserted between the upper and lower boards. The framing member for edging includes a circular arc-shape (which has an arc of curvature same as that of the curved panel) which is bonded to the upper and lower of the panel and a linear-shape which is bonded to be the sides of the panel. The arc-shape framing member is a square timber and the linear-shape framing member is a trapezoid timber. The framing member prevents any distortion phenomenon when the plastic board is compressed. This is to be firmly attached later when the process of finishing is performed with the aluminum profile. After the process is completed, the assembly of curved panel is upward and downward pressed by a hydraulic press to be integrated, thereby bring a manufacturing the curved panel for the acoustical shell to completion.

In manufacturing the curved panel according to the present invention, the plywood and MDF of 1.6 mm˜2.3 mm are mainly used. For a beautiful appearance of the acoustical shell, the melamine pasteboard or a plywood on which a sheet of paper with raw timber pattern is surfaced may be used. It is also possible to manufacture the curved panel at any appropriate thickness and appropriate size as desired by a consumer. Finally, all the edges of the curved panel are overlaid with the aluminum profile to be adhesively bonded and the process is finished by using a fixing means such as a screw. Preferably, the acoustical shell is in a widthwise shape (wherein the curved surface is broad), however, the acoustical shell of lengthwise shape may be used depending on the stage conditions.

### Advantageous Effects

As described above, the acoustical shell according to the present invention has the effects that the efficiency of reflection of sound is excellent and that it is possible to prevent the resonance phenomenon by the cavities in the honeycomb panel of the prior art and to better reflect sound without eliminating even small or soft musical sounds. Besides, the acoustical shell of the present invention has features that it can be easily handled and handy for being installed on the stage because it is light and that it does not deform because of the curved panel structure being formed by heat treatment.

### DETAILED DESCRIPTION OF THE PREFERRED EMBODIMENT

Hereinafter, the preferred embodiments of the present invention will be described in detail with reference to the accompanying drawings. It should be noted that the drawings of the embodiments described below are attached to help in understanding the present invention but not to limit the scope of the present invention.

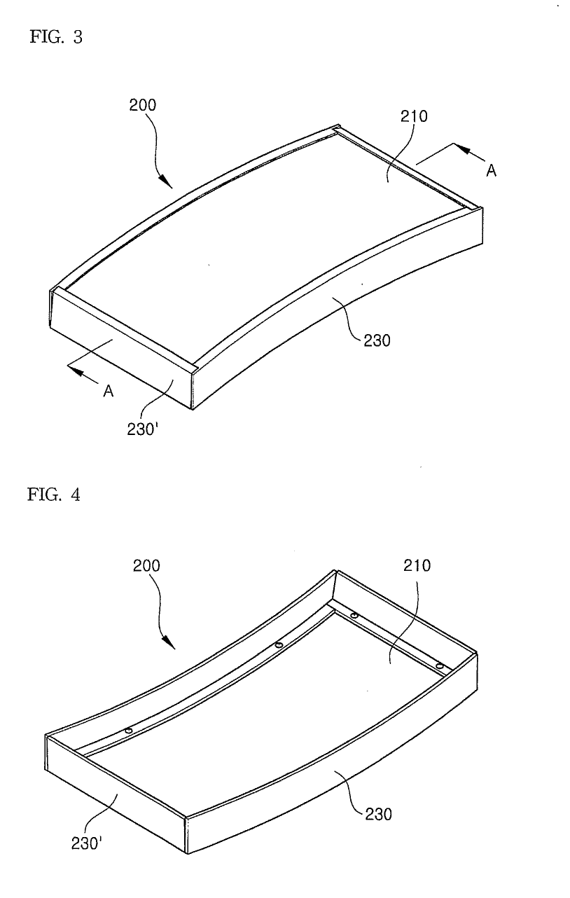

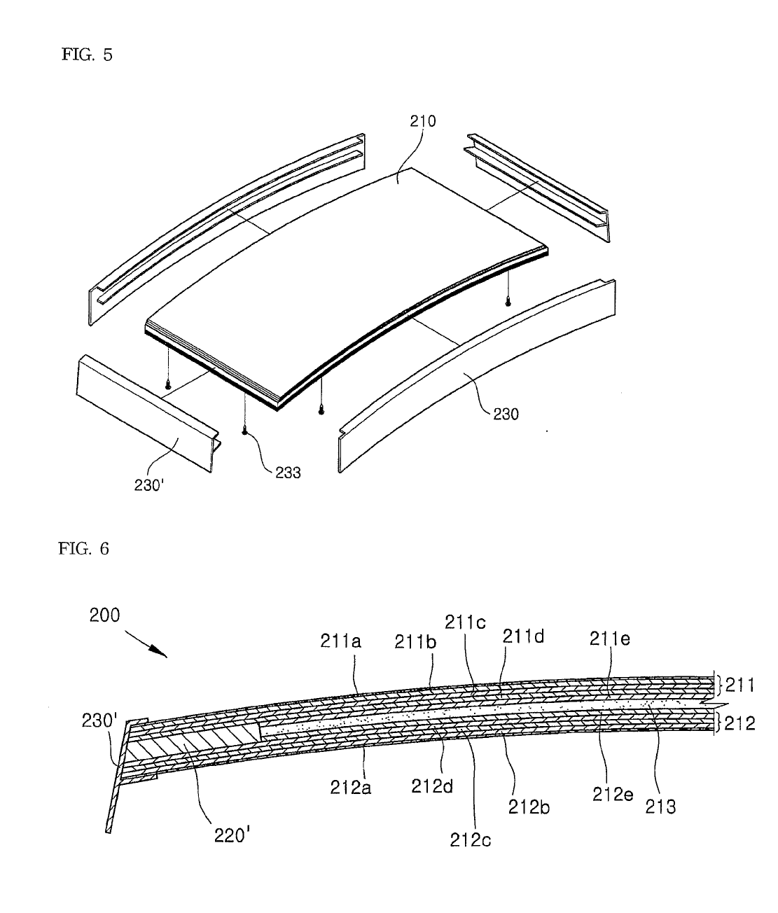

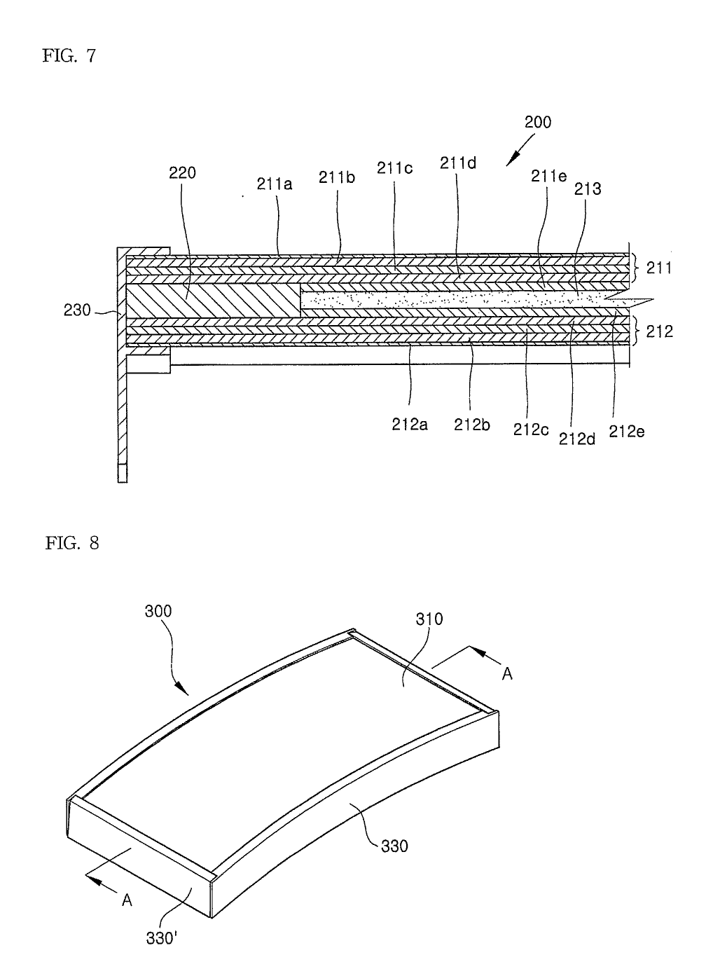

FIG. 3 through FIG. 5 are perspective views of an acoustical shell according to one embodiment of the present invention. FIG. 3 is a plane perspective view of the acoustical shell of the embodiment, FIG. 4 is a rear perspective view of the same, and FIG. 5 is an exploded perspective view. FIG. 6 shows a partial cross sectional view, taken along the line A-A of FIG. 3, and FIG. 7 shows a partial longitudinal sectional view of the acoustical shell of FIG. 3.

With reference to FIG. 3 through FIG. 7, a curved panel 210 for an acoustical shell in accordance with the present invention comprises an upper board 211 having a structure in that a melamine pasteboard 211a being 0.8 mm, a MDF 211b being 2.3 mm, a MDF 211c being 2.3 mm, a plywood 211d being 1.6 mm and a plywood 211e being 1.6 mm are laminated from the surface in sequence, and a lower board 212 in the structure that a plywood 212c being 1.6 mm, a plywood 212d being 1.6 mm, a MDF 212c being 2.3 mm, a MDF 212b being 2.3 mm and a melamine pasteboard 212a being 0.8 mm on the surface are laminated in sequence. A polyester staple fiber gypsum board (SkyBiBa, trademark, SK Chemical Co., Ltd.) 213 having a thickness of 25 mm is inserted between the upper board 211 and the lower board 212 to form the curved panel 210. In this embodiment, the original plate forming a curved surface of the curved panel 210 is adhered and fixed as the curved shape by heating upon manufacturing, and thus it has the feature that the curved surface does not straighten or distort over long periods of time.

Each framing member for edging is connected with each of the upper, lower, right and side ends of the plastic board 213 which being inserted into the curved panel 210 of the acoustical shell 200 in accordance with the present invention, wherein the framing member 220 being of a circular arc is connected with each of the upper and lower ends, and the framing member 220′ being linear is connected with each of the right and left side ends. An aluminum profile 230 is attached in the shape overlaid each end of the curved panel 210, wherein wings 232, 232′ as engaging means are connected with the aluminum profiles 230, 230′ to be integrated, respectively. Preferably, the timber framing member for edging is generally a 3 layered bar plywood, however, a 2 layered bar plywood or a square timber may be employed alternatively. The thickness of the framing member as used in the present embodiment is 20 mm, which is 5 mm less than the thickness of the plastic board 213, such that the plastic board 213 in a foamed like type can be pressed by the upper board 211 and the lower board 212 to be tightly bonded together since the flaming member is thinner in thickness than the plastic board. As explained above, it is possible to prevent the end of the curved panel 210 from being pressed and crooked by inserting the framing member for edging in each end of the curved panel 210 and it is possible to cleanly finish the acoustical shell by attaching the aluminum profiles 230, 230′, plus it is possible to easily assemble the panel by use of a bolt as an engaging means when installing the acoustical shell at the desired place on the ceiling or near the stage or as a movable-type structure around a steel pipe. When attaching the framing member for edging and the aluminum profile, a foamy urethane adhesives (HD-T, trademark, DaeHeng Chemical Co., Ltd.) is used to firmly adhere and connect the framing member and the aluminum profile, and then screws 233 are used in finishing the panel.

### DETAILED DESCRIPTION OF THE EMBODIMENT

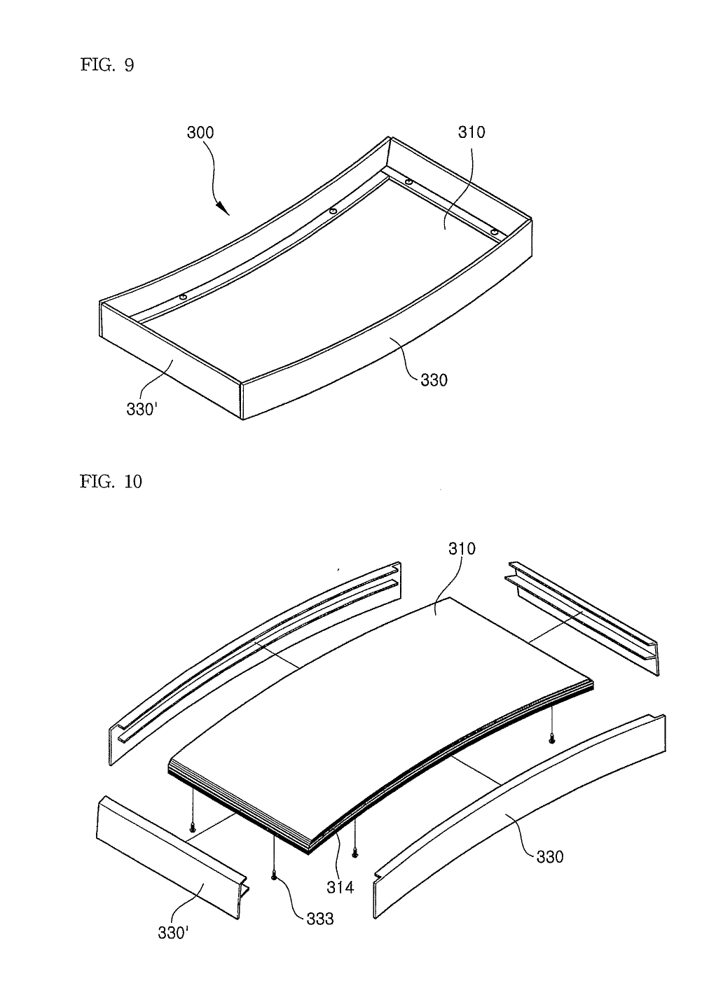

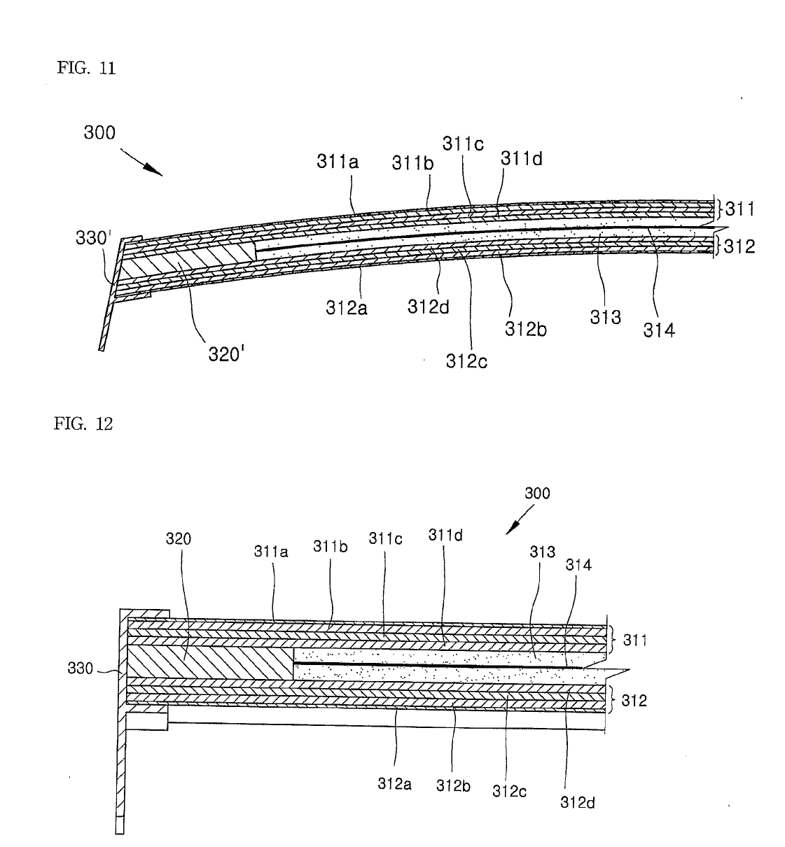

FIGS. 8, 9 and 10 are perspective views of the acoustical shell according to an another embodiment of the present invention. FIG. 8 is a plane perspective view of the acoustical shell of the present invention, FIG. 9 is a rear perspective view of the same and FIG. 10 is an exploded perspective view. FIG. 11 is a partial cross sectional view, taken along the line A-A of FIG. 8 (transversely), and FIG. 12 shows a partial longitudinal sectional view of the acoustical shell of FIG. 8.

With reference to FIG. 8 through FIG. 12, a curved panel 310 for an acoustical shell in accordance with the present embodiment comprises an upper board 311 having the structure that from the surface, a melamine pasteboard 311a being 0.8 mm, a plywood 311b being 1.6 mm. a plywood 311c being 1.6 mm and a plywood 311d being 1.6 mm are laminated in sequence, and a lower board 312 having the structure that a plywood 312d being 1.6 mm, a plywood 312c being 1.6 mm, a plywood 312b being 1.6 mm and a melamine pasteboard 312a being 0.8 mm on the surface are laminated in sequence. A plastic board 313 including aluminum foil 314 and having a thickness of 8 mm is inserted between the upper board 311 and the lower board 312 to form the curved panel 310. In this embodiment, other constitution is same as that of the acoustical shell of FIG. 3. It is possible to manufacture an acoustical shell having a smoother surface if a plywood being 1.6 mm is replaced by a MDF being 2.3 mm for the layer constitution of the plywoods 311b, 312b. References 330, 330′, 320 and 320′, not explained above, indicate a F-shaped (straight F) aluminum profile, a F-shaped (italic F) aluminum profile (see FIG. 14), a round-shaped framing member and a linear framing member, respectively.

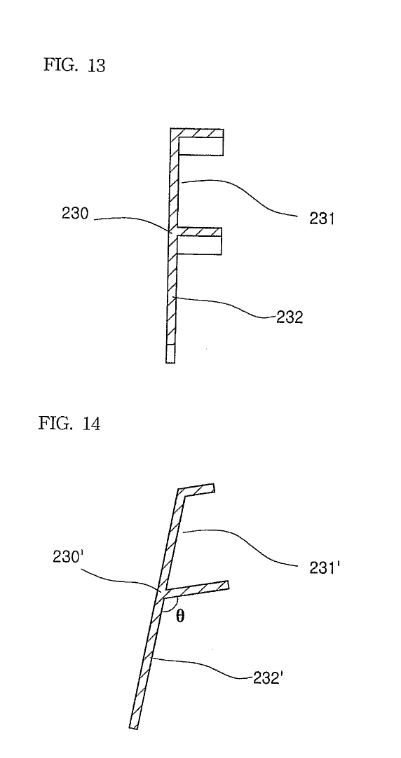

FIG. 13 shows a sectional view of the F-shaped aluminum profile 230 according to the present invention, and FIG. 14 shows the F-shaped aluminum profile 230′ according to the present invention.

With reference to FIGS. 13 and 14, the F-shaped aluminum profile 230 shaped like a pipe wrench comprises a [symbol] -shaped groove 231 which accepts the curved panel thickness and a wing 232 integrated with the [symbol] -shaped groove. The [symbol] -shaped groove 231 has the size in which the end of the curved panel enters and fits therein, the adhesives are applied to the inside of groove 231 to be connected with the curved panel, and then screw 233 is used to fixedly secure and finish the panel. Of the aluminum profiles, the groove 231 is connected with the wing 232 at right angles in the F-shaped aluminum profile 230 to be connected with the upper and lower ends of the curved panel 210, however, the connected angle θ of the groove 231′ and the wing 232′ has an inclination of about 110° in the F-shaped aluminum profile 230′ to be connected with the sides. This is to tightly connect, without any space, the acoustical shells when continuously connecting adjacent acoustical shells in a side by side manner. On an appropriate portion of the wing 232, 232′, a hole is formed for connecting on the existing stage facilities or a movable-type structure (steel pipe or the like) by a bolt, thereby making it possible to easily and readily install the acoustical shell 200 on the stage. If the width of the wing in the aluminum profile is 50 mm, it is appropriate, however, it is possible to handily attach the acoustical shell if the width is 120 mm˜150 mm when the acoustical shell of the present invention should be installed on the existing stage facilities where the acoustical shell of the prior art.

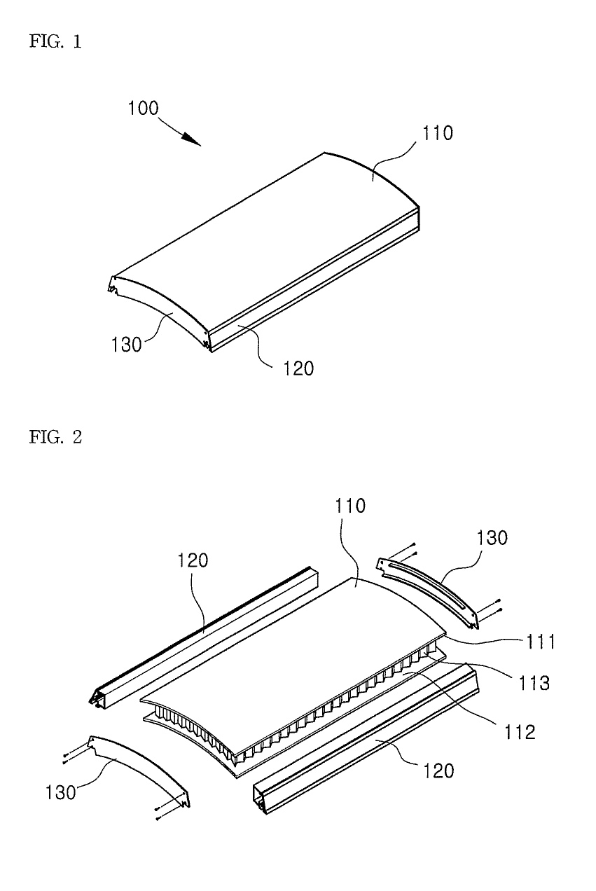

FIG. 1 is a perspective view of an acoustical shell 100 according to the prior application (in Korean Patent Application No. 2004-0058360), and FIG. 2 is an exploded perspective view of the acoustical shell 100, which shows a shape of the acoustical shell is finished with aluminum frames 120, 130 on a panel 110 having a narrow curved surface and a thick shape. The curved panel 110 of the acoustical shell according to the prior application has a structure which is laminated by an upper board 111 having a melamine pasteboard and two layers of plywoods, a honeycomb 113, and a lower board 112 having another two layers of plywoods and another melamine pasteboard.

1. A curved panel for an acoustical shell comprising an upper board, an inserted mid-layer and a lower board, wherein said upper board is a laminate comprising a layer of melamine pasteboard, 2˜4 layers of MDF(s) and/or plywood(s) bonded, and said lower board is a laminate comprising 2˜4 layers of plywood(s) and/or MDF(s), and a layer of melamine pasteboard bonded, which is characterized in that;
said upper board and said lower board are secured by curing to adhesively fix the curved shape in a wood winding machine by heating means; and
said inserted mid-layer is a plastic board attached with framing members for edging on four sides thereof.

2. The curved panel of claim 1, wherein said plastic board is one selected from a foamed polyethylene board, a polyester staple fiber gypsum board or a foamed polyethylene board with aluminum foil inserted into the middle thereof.

3. The curved panel of claim 1, wherein said upper board is surfaced by a sheet of paper with raw timber patterns.

4. The curved panel of claim 1, wherein said framing member for edging is a square timber or a bar plywood and is thinner in thickness than the plastic board.

5. A method of manufacturing a curved panel for an acoustical shell comprising the steps of:
a) manufacturing a laminate by bonding a sheet of melamine pasteboard, 2˜4 sheets of plywood and/or MDF;
b) securing said laminate by curing to adhesively fix the curved shape in a wood winding machine by heating means;
c) assembling the curved panel by adhesively interposing a plastic board attached with framing members between upper and lower boards, wherein said upper and lower boards are prepared for said curved panel; and
d) integrating said assembled curved panel in a curved shape by pressing using a hydraulic press.

6. The method of claim 5, wherein said heating means is a high frequency heating machine.

7. The method of claim 5, wherein said bonding is made by using vinyl acetate emulsion adhesives, isocyanate urethane resin adhesives, or urea resin adhesives.

8. An acoustical shell manufactured by using a curved panel as claimed in claim 1, wherein the upper end and the lower end of said curved panel are overlaid with F-shaped aluminum profiles, and the right side end and left side end of said curved panel are overlaid with F-shaped aluminum profiles, respectively.

9. The acoustical shell of claim 8, wherein said aluminum profile comprises a [symbol] -shaped groove for taking the curved panel, and a wing portion integrally connected with the [symbol] -shaped groove, the F-shaped aluminum profile has a right angle as the angle in which the groove and the wing are connected, and the F-shaped aluminum profile has an inclined angle of about 110° as the angle θ in which the grove and the wing are connected.

10. The acoustical shell of claim 8, wherein said curved panel is a broad-width shape in which a curved surface is wide.

11. A curved panel for an acoustical shell comprising an upper board, an inserted mid-layer and a lower board, wherein said upper board is a laminate comprising a layer of melamine pasteboard, 2˜4 layers of MDF and/or plywood bonded, and said lower board is a laminate comprising 2˜4 layers of plywood and/or MDF, and a layer of melamine pasteboard bonded, which is characterized in that;
said upper board and said lower board are secured by curing to adhesively fix the curved shape in a wood winding machine by heating means; and
said inserted mid-layer is a honeycomb attached with framing members for edging on four sides thereof.
